(19) United States
(12) Patent Application Publication
(10) Pub. No.: US 2013/0007074 A1
(43) Pub. Date: Jan. 3, 2013

(54) Methods and Apparatus for Facilitating Entries Into a Document Registry To Mitigate Access to Restricted Documents without Appropriate Access Credentials

(75) Inventor: Neil Weicher, Stamford, CT (US)

(73) Assignee: COMMUNICATION HORIZONS, LLC D/B/A NETLIB, Stamford, CT (US)

(21) Appl. No.: 13/539,293

(22) Filed: Jun. 29, 2012

Related U.S. Application Data
(60) Provisional application No. 61/504,167, filed on Jul. 1, 2011.

(51) Int. Cl. G06F 17/30

(52) U.S. Cl. 707/821; 707/E17.005

(57) ABSTRACT

In accordance with some embodiments, an article of manufacture, apparatus and/or process provides for removing a file from a registry of files in order to prevent access to a restricted file without provision of the appropriate access credentials. For example, one embodiment provides for monitoring a registry of files; recognizing a registration of a first file in the registry of files; determining a unique identifier corresponding to the registration of the first file; and removing, using the unique identifier, the registration of the first file from the registry, thereby removing the unique identifier from the registry.

### PRIORITY CLAIM TO EARLIER FILED APPLICATION

The present Application claims the benefit of Provisional Patent Application Ser. No. 61/504167, filed Jul. 1, 2011 in the name of Neil Weicher. The entirety of this Provisional Patent Application is incorporated by reference herein for all purposes.

### BRIEF DESCRIPTION OF THE DRAWINGS

FIG. 1 is a block diagram illustrating an example system, consistent with some embodiments described herein.

FIG. 2 is a block diagram illustrating an example computing device, consistent with some embodiments described herein.

FIG. 3A is a table illustrating an example of Document Registry (e.g., ROT), consistent with some embodiments described herein.

FIG. 3B is a table illustrating the example Document Registry of FIG. 3A, after an example process has been performed to remove certain data stored in the Document Registry, consistent with some embodiments described herein.

FIG. 4 is a flowchart of an example process, consistent with some embodiments described herein.

FIG. 5 is a flowchart of another example process, consistent with some embodiments described herein.

FIG. 6 is a flowchart of yet another example process, consistent with some embodiments described herein.

### DETAILED DESCRIPTION OF SOME EMBODIMENTS

Certain aspects, advantages, and novel features of various embodiments are described herein. It is to be understood that not necessarily all such advantages may be achieved in accordance with any particular embodiment. Thus, for example, those skilled in the art will recognize that the any given embodiment may be embodied or carried out in a manner that achieves one advantage or group of advantages as taught herein without necessarily achieving other advantages as may be taught or suggested herein.

Although several embodiments, examples and illustrations are disclosed below, it will be understood by those of ordinary skill in the art that the inventions described herein extend beyond the specifically disclosed embodiments, examples and illustrations and includes other uses of the inventions and obvious modifications and equivalents thereof. Embodiments of the inventions are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the inventions. In addition, embodiments of the inventions can comprise several novel features and it is possible that no single feature is solely responsible for its desirable attributes or is essential to practicing the inventions herein described.

Applicant has recognized a potential security risk to password protected, encrypted or other documents to which access is to be restricted in some manner (“restricted documents” herein), which would allow a user to gain access to the contents of the restricted document without knowing or entering the password, decryption key or other “access credentials” intended to be required for access to the restricted document. This potential security risk is present in environments such as Microsoft™ Office™ and Open Office™, due to the implementation of a Microsoft™ Office™ and Open Office™ (collectively “Office™” herein) feature called “Automation”, which allows a user to import a document (or some content of a document) from one part of Office™ into another. Using the Automation feature a user can import content from a previously opened document into another document. For example, a user can import: (i) an Excel™ spread sheet into a Word™ document, or vice-versa; (ii) one Word™ document into another Word™ document; (iii) one Excel™ spreadsheet into another Excel™ spreadsheet; (iv) a Visio™ diagram into a Word™ document; and/or (v) an Access™ table from one Access™ database into another Access™ database.

It should be noted that the term “document”, as it is used herein unless indicated otherwise, refers to any collection of data electronically stored as a single unit under a single name, which may be a work created with the aid of a software application, such as a WORD, EXCEL or PDF file, or an image file) or any file in any format which may be accessed by a computing device (e.g., a filed opened by an Office™ application, including a Word™ document, an Excel™ spreadsheet, an Access™ database, etc.). It should be noted that the terms “document” and “file” are used interchangeably herein and that a document or file may or may not contain executable program code therein.

It should further be noted that the term “application”, as it is used herein unless indicated otherwise, refers to any software, program, or program module which, when executed by a processor, causes the processor to perform one or more functions (e.g., open or import a document or a portion thereof) and may include a user interface for allowing a user to create works using the application and/or to direct the application to perform certain functions. Examples of applications include, without limitation, Microsoft™ Office™ applications such as Word™, Access™ or Outlook™ and Open Office™ applications such as Writer, Calc, Impress, Draw, Base and Math. In some embodiments an application may comprise a custom application operable to open or import a document by using software developer lines of code referred to as application programming interfaces (APIs), such as Microsoft™ provided standard APIs. It should be understood that various manners of importing documents are contemplated within the embodiments described herein. For example, a user may import a document manually or programmatically through Macros. If done programmatically, the Macro may, for example, call the GetObject API. It should be understood that descriptions herein referring to the importing of a document encompass the importing of portions or subsets of the content of the document and that it is not intended that an entire document be imported in such embodiments.

In order to provide context for some embodiments described herein, what follows is a description of how a user may use an Office™ Automation feature to open a restricted document without having to provide the access credentials otherwise required for accessing the restricted document. First, it should be understood that when a user opens a document with an application, the application generally opens the document or file (or an instance of the document or file, considered equivalent herein) and reads it into memory. The application then adds a reference to the document and to itself (e.g., Word™, Access™, or Excel™) to an internal Windows™ table called the RunningObjectTable (“ROT” herein). For example, if the Word™ application opens a document called “Private.doc”, it registers two entries into the ROT indicating that the application (i.e., Word™) has opened the document “Private.Doc”. In other words, the ROT is a globally accessible lookup table that keeps track of currently running documents, files or objects. These opened or currently running documents, files or objects can be identified in the ROT by a unique identifier (sometimes referred to as a moniker). Thus, when a client or user device attempts to open an instance of a document, file or object (and, e.g., bind a moniker to an object), the ROT may be checked to determine whether the object is already running This allows the moniker to bind to the current instance rather than loading a new instance of the document. This process of opening and registering a document may be analogized somewhat to a user taking a book out of the library and then putting the user's name (i.e., the application) and the name of the book (i.e., the document) the user is taking out on a centralized bulletin board. This lets other users know that the particularly identified user has the book out, thus allowing the other users to come and read the book over the user's shoulder because they are able to identify the user and the book (i.e., import the document/book).

Under the process utilized by the Office™ Automation feature, a second application being used by a user (either the first user who first opened the document using the first application or another user) may be instructed to import a document previously opened (and thus registered in the ROT) by a user will first look in the ROT to see if the document is registered there. If it is not registered in the ROT, the second application will open the document and read it in, as above. However, if the document is registered in the ROT, the second application will issue a GetObject API to instruct Windows™ to transfer (i.e., import) the document from the first application to the second application (or from a first document to a second document, both documents within the same application). This is all done without the second application opening the file or document previously opened or registered. This background process of the second application is done entirely in the computer's memory. This process of the second application looking to the ROT to determine whether a particular document is already opened and registered may be analogized somewhat to a second user looking up a desired book on the centralized bulletin board of a library to determine whether another user already has the book out. If the book is not listed on the board, the second user finds the book on the shelf, takes the book out, opens it and starts reading it. If the book is listed on the centralized bulletin board the second user determines who already has the book (the first application), what book it is (i.e., the document) and comes over and reads over the first user's shoulder without having to him/herself take the book out.

Applicant has recognized that the above-described process of allowing a second application to access a document previously opened by a first application by using the information in the ROT presents a significant security risk for documents which are encrypted, password protected or which otherwise may have a restriction associated therewith (restricted documents). To briefly review the Automation mechanism, it should be appreciated that a user attempting to access a restricted document is only prompted for the access credentials associated with the document when opening the document (i.e., when the application being used to access the document has to actively open the document because it is not registered in the ROT and thus accessible to the user/application desiring to import content from the restricted document). Once a user successfully provides the access credentials for a restricted document and it is therefore opened, the application opening the restricted document reads the document into memory and places two entries in the ROT: the identity of the first application (e.g., Word) which opened the document, and the document name. Of course, other information may also be stored (e.g., file path or other location for the document, user who requested the document be opened, etc.). In the Automation process of Microsoft™ Office™, when a second application subsequently attempts to access a document in order to import content thereof, irrespective of whether the document is a restricted document or not, the Automation process directs that the second application will first look in the ROT to see if the document is registered there. If it is not registered in the ROT, the second application will open the document file, the user will be prompted for the access credentials and, if the user desiring to import the content from the restricted document does not provide the correct access credentials, the second application will fail to open the restricted document (and the user will thus be unable to access or import content from the restricted document). However, if the document is registered in the ROT, the second application will simply issue a GetObject API to instruct Windows to transfer or import the document from the first application to the second application (e.g., through memory such as RAM) or to transfer content from a first document to a second document, thereby bypassing any prompting of the user for the access credentials. Thus, the second application may gain access to the document or content within the document without itself opening the file and without requiring the access credentials that would otherwise be requested of the associated user if the document needed to be opened. Thus, a user who does not know the access credentials for a restricted document may be able to gain access to the document or content of the document by attempting to access the document after it has already been opened by another user who does know (and provided) the required access credentials for the document.

It should be emphasized that in the above description, and in other embodiments described herein, it need not necessarily be a second application that reviews the content of the ROT to determine whether a requested document is already opened and registered in the ROT. It may be the same application, with the action being requested comprising a command to import content from a first document of the first application to a second document of the same application.

Returning again to the library analogy (for illustrative and non-limiting purposes only), assume a book a first user would like to read is under lock and key (e.g., in a “restricted” section of the library). Assume further that in order to take the book out of the restricted section to read it, a user is required to give the librarian a key, pin code, specially designated library card or some other required indicator of permission to take the book out of the restricted section (i.e., user needs to provide access credentials in order to take a book out of the restricted section). Assume further that any book successfully taken out of the restricted section is identified on a central bulletin board, along with the name and location of the first user who has successfully taken it out. Thus, a second user who does not have the requisite permission indicator allowing him/her to take the book out of the restricted section may simply look on the centralized bulletin board to see if the book has been taken out. If it is not identified on the bulletin board, the second user would need to go to the librarian to take the book out. Since the second user does not have the requisite permission indicator, the second user would not be granted access to the book. However, if the book is listed on the board, the second user can simply identify the first user and location of the book and come over to the location to read the book over the first user's shoulder without having the required permission indicator.

Applicant has thus recognized that there is a need to modify the Office™ Automation process, or institute an additional process which may run parallel to or otherwise with or complementary to, the Automation process, such that a second application (or same application) is prevented from accessing a restricted document (or content thereof) without providing the required permission indicator for accessing the restricted document. Applicant has further recognized that the security risk inherent in the Automation process is made even more acute in network or cloud environments in which an ROT may be accessed remotely and/or from multiple terminals or user devices, or environments in which multiple users have access to a given user device.

Accordingly, consistent with some embodiments, are processes, non-transitory computer-readable mediums and systems which provide for (i) monitoring, via a first software application, a registry of files (e.g., an ROT of a computing device is monitored by a non-Microsoft™ third party application); (ii) recognize, via the first software application a registration by a second software application of a first file in the registry of files (e.g., the third party application recognizes that a Microsoft application has stored information about an opened file or document in the ROT); (iii) determine, via the first software application, a unique identifier corresponding to the registration of the first file (e.g., the third party application determines a unique identifier sometimes referred to as a file moniker in the Microsoft™ Windows™ environment, assigned to each new file registered in the ROT); and (iv) remove, via the first software application and using the identifier, the registration of the first file from the registry, thereby removing the unique identifier from the registry (e.g., third party application uses the file moniker to “erase” information from the ROT which would allow another application to access the file).

In one embodiment, rather than removing all files or documents from the ROT, the third party application may be operable to determine whether the file is associated with one or more predetermined characteristics (e.g., whether the file is a restricted file or restricted document in that it is a password protected or encrypted document) and only remove information about the file from the registry if the file is associated with the one or more characteristics (e.g., only remove information associated with restricted filed, thus only preventing another application from accessing content of restricted files using the ROT).

In one embodiment, rather than removing a file from the ROT (whether the removal be only for restricted files or all file), the third party application may be programmed to alter data associated with a particular file in the ROT. For example, the third party application may be programmed to essentially sabotage another application's ability to correctly identify and/or locate an opened file by altering the file name, file path and/or application name (the name of the application which opened the file) as stored in the ROT.

In yet another embodiment, rather than utilizing an application (e.g., a third party application which is not a Microsoft™ application) which monitors entries into the ROT and removes all or some entries from the ROT, one or more processes of Microsoft™ Office™ may be altered such that not all opened files are registered or stored in the ROT or such that some or all files stored in the ROT are then removed from the ROT. For example, in accordance with one embodiment, prior to storing information about an opened file in the ROT, a relevant process may determine whether the file corresponds to one or more predetermined characteristics (e.g., it may be determined whether the file is a restricted file, such as a password protected or encrypted file). In this embodiment, only files that are not restricted file or that do not otherwise correspond to the one or more characteristics may be registered in the ROT. In another embodiment, all files registered in the ROT are immediately removed from the ROT in order to prevent unauthorized access to the files.

In yet another embodiment involving a process of Microsoft™ Office™, a relevant process which registered opened files in the ROT may be modified to store additional data in the ROT which is not currently stored, such as the required access credentials associated with a restricted file. For example, the relevant process may be modified such that it is operable to determine whether the file being opened is a restricted file (e.g., whether the file is password protected or encrypted), determine the access credential associated with the restricted file (e.g., the password or decryption key required for accessing the restricted file) and store an indication of the access credentials in the ROT. For example, the access credentials (e.g., password) may be stored in the ROT or a flag or other indicator may be stored, indicating that the particular file is a restricted file (e.g., a moniker assigned to a restricted file may begin or end with a designated symbol, numeral or code, indicating that the associated file is a restricted file). Thus, any process or application which subsequently attempts to access the restricted file may be programmed to check as to whether the file is a restricted file based on the standard adopted for identifying restricted files in the ROT, and to then prompt a user attempting to access the restricted file via the ROT for the appropriate access credentials.

It should be noted that in embodiments described herein which involve a Microsoft™ Office™ or Open™ Office™ application itself monitoring registrations of files in an ROT or other registry of files, an application which is opening or accessing a document may perform the monitoring and removal or modification of information of a file in the ROT in accordance with embodiments described herein. For example, a set of instructions, code or executable functions or data (e.g., a Dynamic Link Library or “DLL”) may be injected into (or otherwise made available or accessible to) Windows™ and/or an Office™ application. The instructions, code or executable functions or data may cause an application to perform one or more of the functions described herein. For example, it may cause the application to monitor events for a request to open a file (e.g., a request within the subject application or another application) and (1) remove an indication of a file from an ROT or other registry of files after it has been added thereto; (ii) modify or add information stored in the ROT or other registry of files which would require a user subsequently attempting to access the file vis-a-vis the registry to be prompted to input access credentials; and/or (iii) prevent an indication of the file from being entered into the ROT or registry of files. It should be noted that any of the functions (i) through (iii) in the preceding sentence may be performed for all files identified by the monitoring step or only for files associated with one or more predetermined characteristics (e.g., restricted files).

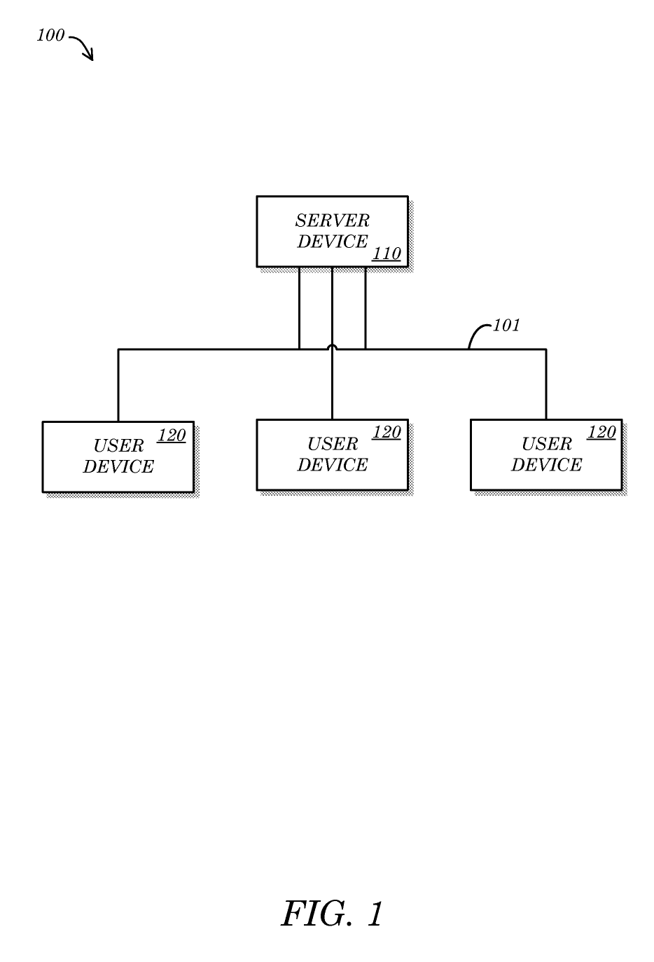

Turning now to FIG. 1, illustrated therein illustrated therein is an example system 100 consistent with one or more embodiments. The system 100 comprises a server device 110 and a plurality of user devices 120; each device of system 100 may in some embodiments be operable to communicate with at least one other device of system 100 via a network 101. The network 101 may comprise, for example, the Internet, a wide area network, another network or a combination of such networks. Additionally, in some embodiments one or more of the devices of system 100 may be located behind a firewall (not shown). In some embodiments, system 100 may be configured such that server device 110 may communicate with one or more of the user devices 120 in such a way as to be uninhibited by the existence of any firewall. It should be understood that although not shown in FIG. 1, other networks and devices may be in communication with any of the devices of system 100. For example, a user device 120 may comprise a mobile device which may be in communication with a mobile network (not shown) such as a pager or cellular telephone network that accommodates wireless communication with mobile devices as is generally known to those skilled in the art.

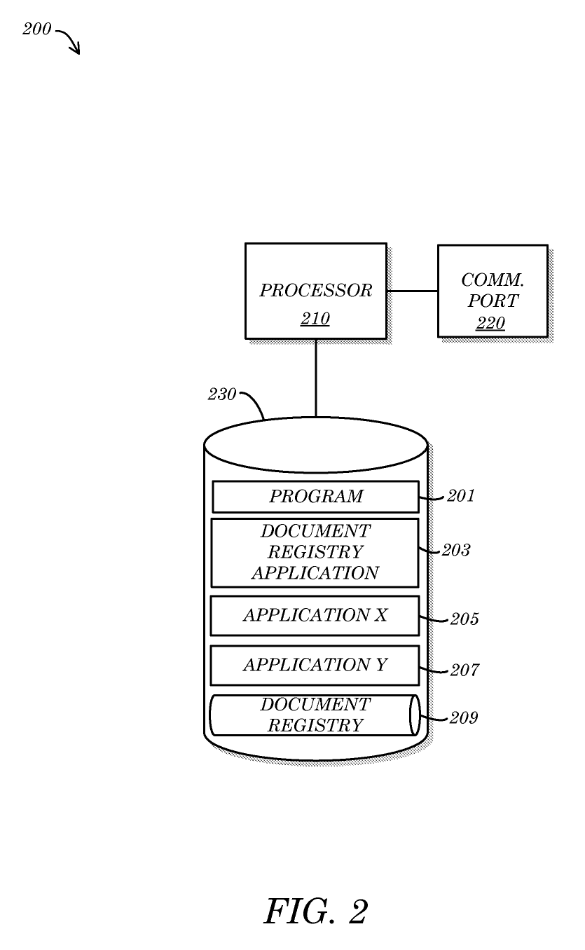

The server device 110 may comprise one or more computing devices, working in parallel or series if more than one, operable to facilitate the functions described herein. A more detailed description of an example server device 110 is provided herein with reference to FIG. 2.

A user device 120 may comprise, for example, a computing device operable to store, open, access, create, manipulate and/or perform other functions related to documents. A user device may further comprise, for example, one or more applications which are stored locally in a memory of the user device or accessible remotely by the user device. In some embodiments a user device 120 may comprise a computing device such as a desktop, laptop or other user terminal via which files may be accessed. In other embodiments a user device 120 may comprise, for example, a mobile or portable computing device such as a smartphone (e.g., the IPHONE manufactured by APPLE, the BLACKBERRY manufactured by RESEARCH IN MOTION, the PRE manufactured by PALM or the DROID manufactured by MOTOROLA), a Personal Digital Assistant (PDA), cellular telephone, laptop or other portable computing device.

It should be understood that each of the devices 110 and 120 may communicate directly or indirectly, via a wired or wireless medium such as the Internet, LAN, WAN or Ethernet, Token Ring, or via any appropriate communications means or combination of communications means. For example, in one embodiment communication among any and all of the devices of system 100 may occur over the Internet through a Web site maintained by computer on a remote server or over an on-line data network including commercial on-line service providers, bulletin board systems and the like. In yet other embodiments, communication among any of the devices of system 100 may occur over RF, cable TV, satellite links and the like.

The system 100 may be operable to facilitate communication among the devices 110 and 120 using known communication protocols. Possible communication protocols that may be part of the system 100 include, but are not limited to: Ethernet (or IEEE 802.3), ATP, BLUETOOTH, HTTP, HTTPS and Transmission Control Protocol/Internet Protocol (TCP/IP). Communication may be encrypted to ensure privacy and prevent fraud in any of a variety of ways well known in the art, some of which are described herein.

It should be understood that although a plurality of user devices 120 and one server device 110 are illustrated, any number of user devices 120 and server devices 110 may be embodied in a system operable to facilitate the functions described herein. In some embodiments, the processes described herein may be employed on a single or stand-alone user device (e.g., a user device not in communication with any other user device, network or server device).

Turning now to FIG. 2, illustrated therein is a block diagram of a computing device 200 (which may be one embodiment of server device 110 and/or a user device 120 of FIG. 1). The computing device 200 may be implemented as a system controller, a dedicated hardware circuit, an appropriately programmed general-purpose computer, or any other equivalent electronic, mechanical or electro-mechanical device. The computing device 200 may comprise, for example, one or more server computers operable to communicate with (i) one or more user devices 120 (FIG. 1), such as on a closed or open network; and/or (ii) one or more additional devices (e.g., a remote storage server device for storing data such as documents and/or applications accessible to computing device 200). In another embodiment, the computing device 200 may comprise a user device (e.g., a user device accessible or usable by multiple users and/or accessible via a remote server or other computing device). In accordance with some embodiments, the computing device 200 may be operative to manage the system 100 and/or to facilitate at least some functions or procedures described herein. The computing device 200, as well as components thereof, may be implemented in terms of hardware, software or a combination of hardware and software.

The computing device 200 comprises a processor 210, such as one or more INTEL PENTIUM processors. The processor 210 is in communication with a communication port 220 (e.g., for communicating with one or more other devices, such as one or more user devices 120) and a memory 230. The memory 230 may comprise an appropriate combination of magnetic, optical and/or semiconductor memory, and may include, for example, Random Access Memory (RAM), Read-Only Memory (ROM), a compact disc and/or a hard disk. The processor 210 and the memory 230 may each be, for example: (i) located entirely within a single computer or other device; or (ii) connected to each other by a remote communication medium, such as a serial port cable, telephone line or radio frequency transceiver. In one embodiment, the computing device 200 may comprise one or more devices that are connected to a remote server computer for maintaining databases.

The memory 230 stores or is operable to access a program 201 for controlling the processor 210. The processor 210 performs instructions of the program 201, and thereby operates in accordance with at least some of the methods described in detail herein. The program 201 may be stored in a compressed, uncompiled and/or encrypted format. The program 201 furthermore includes program elements that may be necessary, such as an operating system, a database management system and “device drivers” for allowing the processor 210 to interface with computer peripheral devices. Appropriate program elements are known to those skilled in the art, and need not be described in detail herein. The memory 230 further stores or is operable to access a Document Registry Application 203 (which, alternatively, may be part of the program 201) which also may be stored in a compressed, uncompiled and/or encrypted format and include instructions which, when performed by the processor 210, cause the processor 210 to operate in accordance with at least some of the methods described herein. For example, the Document Registry Application 203 may include computer program code that allows the processor 210 to, without limitation:
1. Monitor a Document Registry (e.g., Document Registry 209, described herein, which may comprise a ROT) in order to identify any information written to it or stored in it (e.g., data identifying a newly opened file, such as a moniker or other unique identifier for the file and/or another application which opened the file);
2. Determine a unique identifier for a file being registered in a Document Registry;
3. Use the unique identifier to remove data associated with the file (e.g., remove the registration of the file in the ROT);
4. Determine whether a file being registered with a Document Registry (e.g., the ROT) is a restricted file or is associated with a predetermined characteristic;
5. Add data to a Document Registry to be associated with a particular document (e.g., if the document is determined to be associated with a predetermined characteristic);
6. Determine whether to add an indication of a document to a Document Registry (e.g., an indication of the document only to be added to the Document Registry if the document is associated with a predetermined characteristic); and/or
7. Alter data associated with a registered file in a Document Registry such as the ROT (e.g., add an indicator or flag identifying the document as a restricted document; and/or alter an application identifier, document name and/or file path for a registered document, thus impeding the ability of another application to correctly identify or locate the file in order to access content thereof).

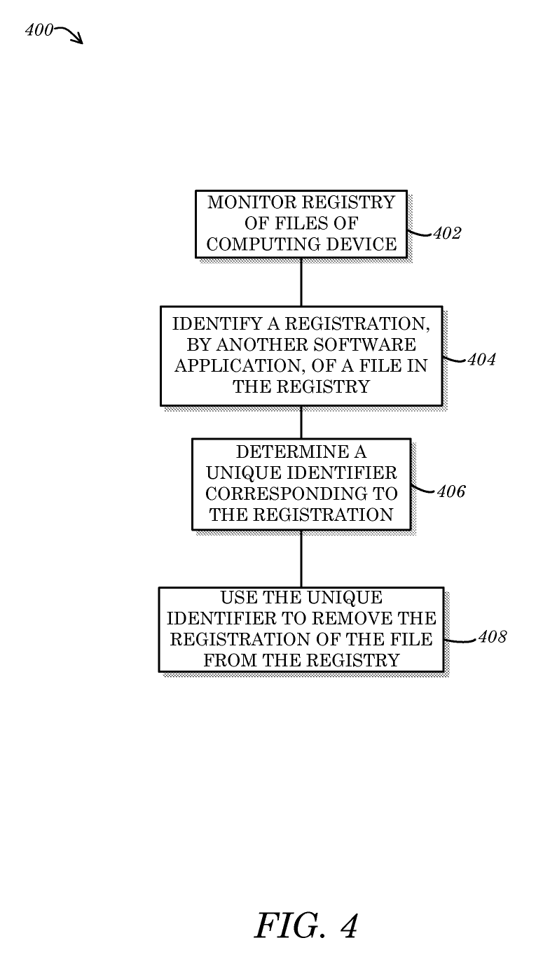

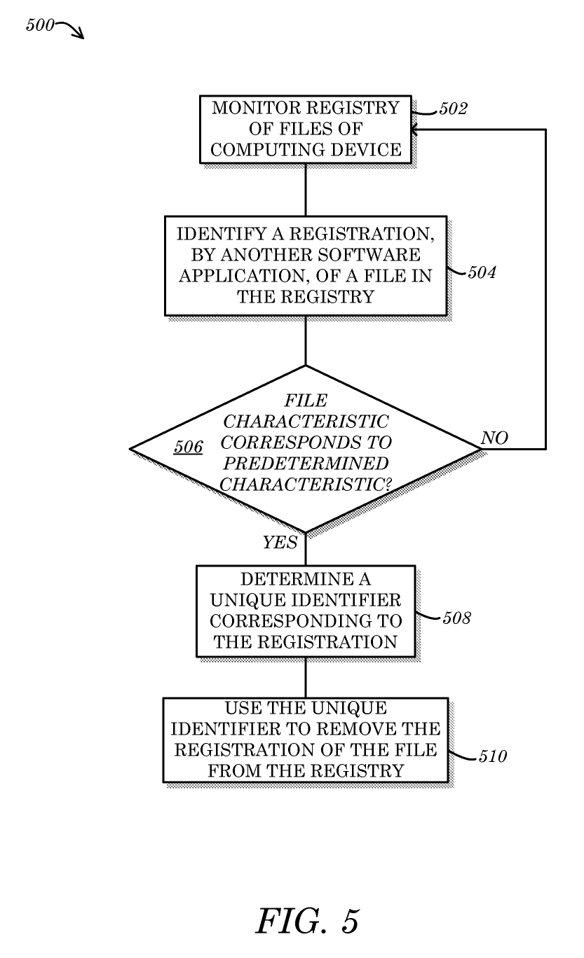

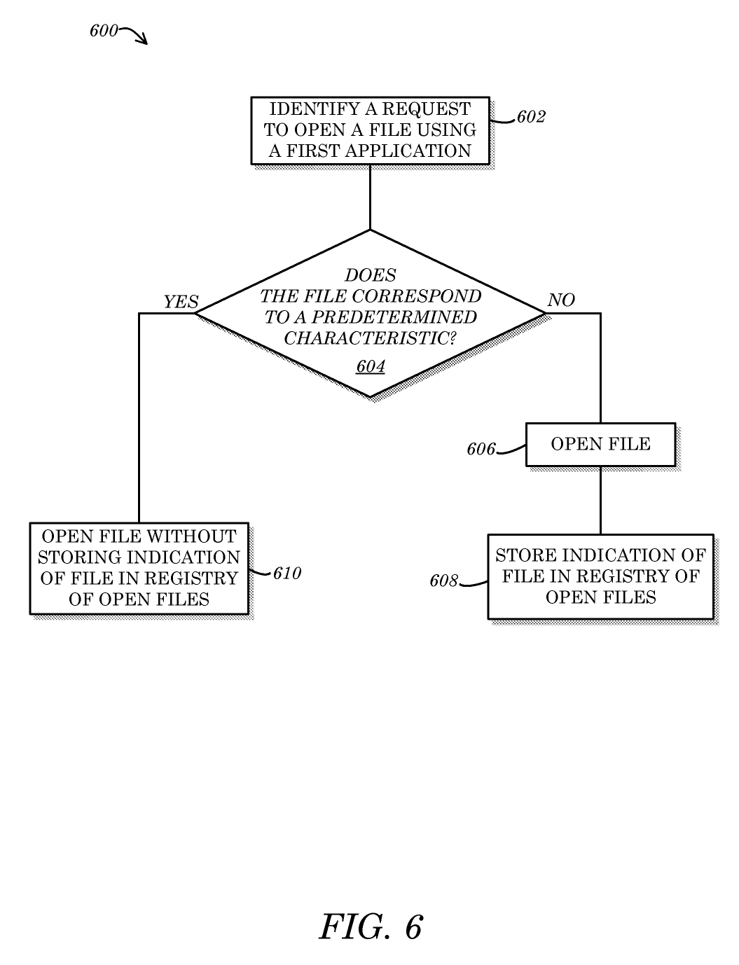

According to some embodiments, computing device 200 may be operable to perform some of the processes (or portions thereof) described herein. For example, computing device 200 may be operable to perform at least a portion of the process 400 (described with respect to FIG. 4), process 500 (described with respect to FIG. 5), process 600 (described with respect to FIG. 6) and/or any other process described herein.

According to an embodiment, the instructions of the program 201 and/or the Document Registry Application 203 may be read into a main memory from another computer-readable medium, such from a ROM to RAM. Execution of sequences of the instructions in the program 201 and/or the Document Registry Application 203 causes processor 210 to perform the process steps described herein. In alternate embodiments, hard-wired circuitry may be used in place of, or in combination with, software instructions for implementation of the processes of the present invention. Thus, embodiments of the present invention are not limited to any specific combination of hardware and software.

In accordance with some embodiments, the memory 230 may also store or be operable to access one or more other applications, such as Application X 205 (e.g., a Microsoft™ Word™) and a Application Y 207 (e.g., Microsoft™ Excel™). The terms “X” and “Y” are used merely to denote that the two applications 205 and 207 may, in some embodiments, comprise distinct applications which are distinct from one another and distinct from the Document Registry Application 203. Of course, as described herein, in some embodiments a single application may be utilized to both initially open a document and subsequently attempt to import content of that document into another document and the illustration of two distinct applications is not intended to imply that at least two document applications are necessary for such processes. Application X 205 and/or Application Y 207 may comprise, for example, an application operable to create, modify, open or access content of a document or file. For example, a user may open a document using Application X 205 and subsequently, a user (the same user or a different user) may attempt to access the same document using Application Y 207 (e.g., a different user may attempt to import content of the document initially opened using Application X 205 into another document using Application Y 207).

It should be noted that in some embodiments, Application X 205 and Application Y 207 may be components of a suite of applications designed, developed or offered for sale by the same party and operable to communicate and interact with one another (e.g., such as the applications of Microsoft™ Office™). In other embodiments, Application X may be designed or developed by a first party while the Application Y may be designed or developed by a second party (yet even in such an embodiment, the Application X and the Application Y may be operable to interact and/or be compatible in at least some respects).

It should further be noted that in some embodiments, the Document Registry Application 203 may be an application of a third party (i.e., a party other than a designer, developer or seller of Application X 205 or Application Y 207), operable to facilitate some of the processes described herein. For example, Document Registry Application 203 may be operable to facilitate at least some of the steps of process 500 (described with respect to FIG. 5). In such embodiments, the Document Registry Application 203 may be operable to determine, recognize and/or utilize certain information or data created, stored or modified by Application X 205 and/or Application Y 207 (e.g., it may be operable to recognize a file registered by one of these applications in a file registry and/or modify the file registry). The Document Registry Application 203 may be operable to do this even though it may not be authorized or pro-actively made compatible with Application X 205 and/or Application Y 207 by the respective designer, developer or seller of one or more of these applications.

In other embodiments, Document Registry Application 203 may be an application of the same party which designed, developed and/or offers for sale Application X 205 and/or Application Y 207 (and may therefore in such embodiments be designed to be more integrated and cooperative with one or both of these applications). For example, in some such embodiments Document Registry Application 203 may be an application comprising a suite of applications designed, developed or offered for sale by the same party which designed, developed or offers for sale Application X 205 and/or Application Y 207. In such embodiments, the Document Registry Application 203 may be operable to facilitate or modify processes for registering files in a file registry (e.g., such as the process 600 of FIG. 6 and/or process 700 of FIG. 7).

In some embodiments, Document Registry Application 203 may comprise a program, instructions or executable functions or data (e.g., a DLL) which may be injected into or otherwise made accessible to or a part of Application X 205 and/or Application Y 207. In some embodiments, such an injection or availability of the Document Registry 203 may be done by the same party (or with the permission of the party) which designed, developed and/or offers for sale Application X205 and/or Application Y207. In other embodiments, such an injection or availability may be done without the permission of such a party.

The memory 230 also stores a Document Registry 209, which may in some embodiments be in the format of a database or table. A Document Registry, as the term is used herein unless indicated otherwise, refers to a record, listing or compilation of information related to documents open on or accessible to Computing Device 200. A Document Register may store a record of events pertaining to one or more documents, such as the dates and/or times a particular document was opened or closed, the current status of a document, a location of a document, a name of an application associated with the document (e.g., an application which was used to create or open the document), a user associated with the document, a password or other access credentials associated with the document, and/or any flags or indicators which identify one or more characteristics of the document (e.g., that the document is a restricted document). In accordance with some embodiments, the Document Registry 209 may comprise, for example, an embodiment of the ROT of Microsoft™ Office™. Of course, the Document Registry 209 may comprise a registry other than the ROT. Of course, additional or different tables or databases may be used to store information helpful in carrying out the processes described herein.

It should be noted that in some embodiments (e.g., embodiments using cloud or other centralized storage to some extent), any or all of the applications, databases or data described herein as being stored or accessible by memory 230 may alternatively or additionally be stored in another location (e.g., a memory of a server computer the computing device 200 is operable to communicate with) and/or accessible to another component of the computing device 200 (e.g., processor 210).

Although the Document Registry 209 is described as being stored in the memory 230, in other embodiments this Registry may be partially or wholly stored, in lieu of or in addition to being stored in a memory of computing device 200, in a memory of one or more other devices. Such one or more other devices may comprise, for example, another computing device with which computing device 200 is operable to communicate. Further, some or all of the data described as being stored in the memory 230 may be partially or wholly stored (in addition to or in lieu of being stored in the memory 230) in a memory of one or more other devices. Such one or more other devices may comprise, for example, a remote storage service server (e.g., an online back-up storage server, as would be understood by one of ordinary skill in the art).

In some embodiments the computing device 200 may be operable to configure itself or another device (e.g., in embodiments in which the computing device 200 comprises a server device, it may be operable to configure an associated user device), update software stored on itself or another associated device and /or to download software or software components to itself or another device. Any of the foregoing may be done remotely or locally. In one example embodiment, a remote server device comprising computing device 200 may be operable to download (e.g., at the request of a user) software to a user device, software that facilitates the user device in communicating with the remote server to facilitate the storing, removing and/or modifying of data in a Document Registry associated with the user device and/or server device. In another example, the computing device 200 may comprise a user device operable to download (e.g., at the request of a user) software comprising a Document Registry Application (e.g., Document Registry Application 209) comprising a third party application, which Application monitors data added to a Document Registry such as the ROT of Microsoft™ Office™ and removes data associated with all opened documents or documents determined to be restricted documents, consistent with embodiments described herein.

The computing device 200 may in some embodiments comprise any device operable to facilitate input. An input device, as the term is used herein, may be any device, element or component (or combination thereof) that is capable of receiving an input (e.g., from a user or another device). An input device may communicate with or be part of another device. Some examples of input devices include: a bar-code scanner, a magnetic stripe reader, a computer keyboard or keypad, a button (e.g., mechanical, electromechanical or “soft”, as in a portion of a touch-screen), a handle, a keypad, a touch-screen, a microphone, an infrared sensor, a voice recognition module, a coin or bill acceptor, a sonic ranger, a computer port, a video camera, a motion detector, a digital camera, a network card, a universal serial bus (USB) port, a GPS receiver, a radio frequency identification (RFID) receiver, an RF receiver, a thermometer, a pressure sensor, an infrared port, and a weight scale. For example, in one embodiment an authorized person may use an input device of computing device 200 to request that content of a document previously opened via Application X 205 be imported to another document.

The computing device 200 may in some embodiments comprise one or more output devices. An output device may comprise any device, component or element (or a combination thereof) operable to output information from any of the devices described herein. Examples of an output device include, but are not limited to, a display (e.g., in the form of a touch screen), an audio speaker, an infra-red transmitter, a radio transmitter, an electric motor, a dispenser, an infra-red port, a Braille computer monitor, and a coin or bill dispenser.

In some embodiments, a computing device 200 may comprise components capable of facilitating both input and output functions (i.e., input/output devices). In one example, a touch-sensitive display screen comprises an input/output device (e.g., the device outputs graphics and receives selections from an authorized person).

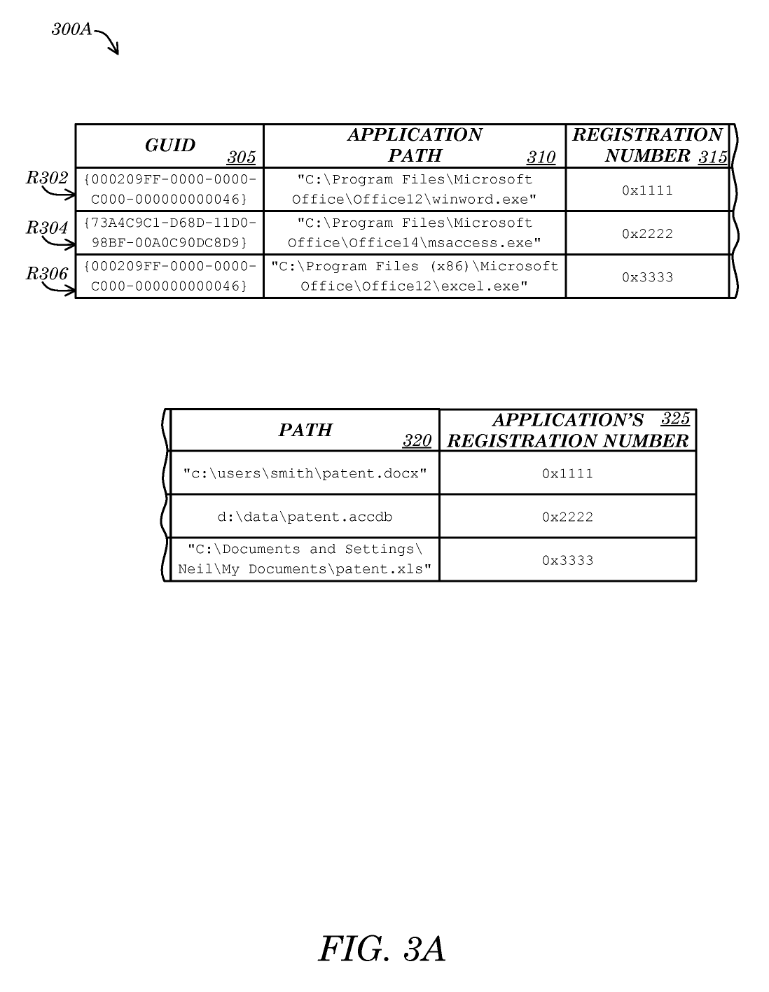

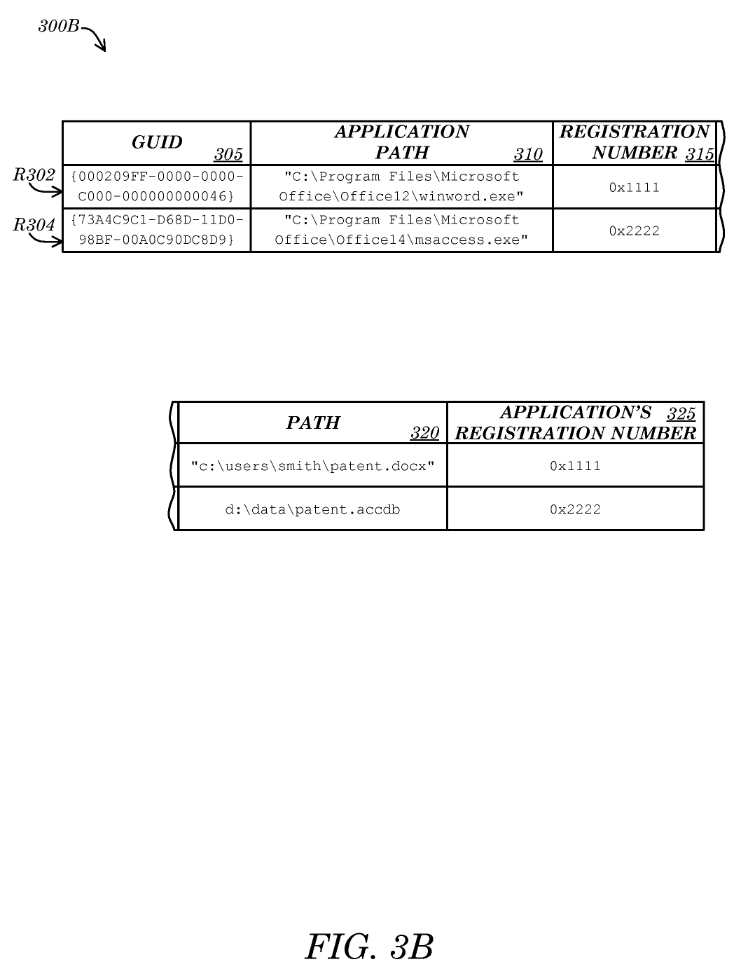

Referring now to FIGS. 3A and 3B, illustrated therein is an example structure and sample contents of a database that may be useful in some embodiments (e.g., a Document Registry 209). FIG. 3A illustrates data stored in an example prior to completion of a process thereupon (e.g. process 400 of FIG. 4) while FIG. 3B illustrates data stored in the database after the completion of the process. The specific data and fields illustrated in FIGS. 3A and 3B represent only some embodiments of the records that may be stored in such databases. The data and fields of such databases can be readily modified, for example, to include more or fewer data fields. A single database that is a combination of multiple databases, or a configuration that utilizes multiple databases for a single database illustrated herein may also be employed. Note that in the databases of FIGS. 3A and 3B, a different reference numeral is employed to identify each field. However, in at least one embodiment, fields that are similarly named (e.g., an application identifier) may store similar or the same data in a similar or in the same data format.

As will be understood by those skilled in the art, the schematic illustration and accompanying descriptions of data contained in the sample database presented herein is an exemplary arrangement for stored representations of information. Any number of other arrangements may be employed besides those suggested by the table shown. For example, the embodiments described herein could be practiced effectively using more functionally equivalent databases. Similarly, the illustrated entries of the database represent exemplary information only; those skilled in the art will understand that the number and content of the entries can be different from those illustrated herein. Further, despite the depiction of the database as a table, an object-based model could be used to store and manipulate the data types of one or more embodiments and likewise, object methods or behaviors can be used to implement the processes of one or more embodiments.

FIG. 3A is a tabular representation 300A of an example embodiment of Document Registry 209 (e.g., as it may be stored in a memory of a computing device 200 and/or in a memory of another device). Tabular representation 300A is referred to herein as document registry database 300A.

The document registry database 300A includes a number of example fields or records R302-R306, each defining a document which has been registered by an application (e.g., an application of computing device 200) as having been opened. Those skilled in the art will understand that a document registry database may include any number of records. The document registry database 300A also defines the following example fields (i) GUID field 305 which stores a Globally Unique Identifier (GUID, also called a Class Identifier) or other unique identifier of the application opening the file or document of the corresponding record; (ii) an application path field 310 which stores a path to the application used to run the application on the computing device on which the file of the corresponding file is opened; (iii) a registration number field 315, which stores an index into the ROT for the file of the corresponding document (which may change each time the application is started); (iv) a path field 325, which stores a path to the file opened; and (v) an application's registration number field 325, which stores a unique registration number of the application that was used to open the file of the corresponding record. The data stored in tabular representation 300A would allow an application (either the same application identified in GUID 305 for a given record or another application) to access the document of a given record if it is still open and therefore its data available in the document registry, without having to open another instance of the document. The example data of FIG. 3A illustrates three (3) different documents as being open and stored in the document registry.

Referring now to FIG. 3B, illustrated therein is a tabular representation 300B of the Document Registry 209, depiction the data in the document registry also depicted in tabular representation 300A but after a process consistent with the embodiments described herein has caused a removal of one of the records (record R306). Thus, for example, a process consistent with embodiments described herein may cause a removal from a document registry of data corresponding to a restricted document. Assuming the document of record R306 has been determined to be a restricted document, an indication of this document as having been opened by an application (even if the document has not yet been closed by the application) has been removed from the document registry to prevent subsequent access of the document without the appropriate access credentials.

Referring now to FIG. 4, illustrated therein is a flowchart of a process 400 consistent with some embodiments. It should be noted that process 400, as well as any other process described herein, is exemplary only and should not be construed in a limiting fashion. For example, additional and/or substitute steps to those illustrated or described for any process herein, (including process 400) may be practiced within the scope of the embodiments described herein and in one or more embodiments one or more steps may be omitted or modified.

In one embodiment, the process 400 is performed by a computing device 200 (which may, as described herein, comprise a user device 120 or a server device 110). For example, the process 400 may be a process of an application (e.g., a Document Registry Application 203 of computing device 200), which runs on a computing device in order to monitor entries made in a Document Registry (e.g., the ROT) by other applications (e.g., an Application X 205 or an Application Y 207 of computing device 200). The process 400 is consistent with embodiments in which access to restricted documents is limited to those users who are able to provide the appropriate credentials by removing entries made in a Document Registry. The removal of an entry thus requires an application which subsequently (subsequent to the initial opening of a document by an application which caused the indication of the opened document to be registered in the Document Registry) attempts to access content of a document to open a new instance of the document and not be able to circumvent providing any required access credentials of the document by utilizing the entry in the Document Registry to locate and access the already opened document. This may be done in order to modify and/or remove the entries such that access to restricted documents is limited to those users who are able to provide the appropriate access credentials.

It should be noted that in some embodiments a Document Registry Application 209 and/or process 400 may run (e.g., in the background) at all times that the computing device with which it is associated is on. For example, process 400 and/or Document Registry Application 203 may be launched each time the computing device is booted up and may run as a background process on essentially a continuous basis. In other embodiments, process 400 and/or Document Registry Application 203 may be initiated upon an occurrence of a triggering event (e.g., a user requests to launch the process, another related application is launched, a document is registered in a Document Registry, a predetermined day and/or time occurs, etc.). In yet other embodiments, process 400 may be injected as a thread into an application which is already programmed to store an indication of a file being opened in a Document Registry, thereby modifying the functionality of the application.

In step 402 a registry of files or documents is monitored on a computing device. For example, in some embodiments an application comprising process 400 (e.g., a Document Registry Application 209) may be associated with one or more computing devices (e.g., a computing device on which it is installed or downloaded or multiple computing devices associated with a server device on which it is installed or downloaded). Thus, step 402 comprises monitoring the registry of files of the one or more computing devices with which process 400 is associated. The registry of files may comprise a registry of files local or specific to a single computing device or a registry of files shared by a plurality of computing devices. The registry of files being monitored may comprise, for example, a Document Registry 209 such as the one embodied as Document Registry table 300A of FIG. 3A. Monitoring the registry of files may comprise, for example, continuous or semi-continuous monitoring and/or periodic monitoring (e.g., the associated registry of files may be checked for new entries every predetermined unit of time, such as every five (5) minutes). The monitoring is performed to identify a new entry being stored in the document registry.

The monitoring of step 402 may comprise, for example, monitoring a data stream or communication mechanism for adding or modifying events or records in the registry of files or monitoring calls to certain applications or program modules. For example, in the Microsoft™ Windows™ environment, when an application or client seeks to register a file or object in the ROT, the computing device operable to register the file in the ROT typically creates a unique identifier or moniker for the object or file and registers it in the running object table (ROT) through a call to “IRunningObjectTable::Register”. The computing device may call the “CreateFileMoniker” action to create a file moniker to be registered in the ROT. The application opening an instance of the file may communicate with a moniker provider application. Thus, in embodiments involving the Microsoft™ Windows™ environment, step 402 may comprise monitoring the activities of the computing device to identify calls to either the “IRunningObjectTable::Register” application or the “CreateFileMoniker” application or monitoring the activities of a moniker provider to identify any new monikers that are being generated, assigned, transmitted or handed out for files being opened.

In step 404, a registration of a file by another application (e.g., Application X 205 or Application Y 207) in the Document Registry is identified. For example, it may be determined that the application is transmitting data to the Document Registry and/or initiating calls to certain modules, such as the “IRunningObjectTable::Register” application or the “CreateFileMoniker” application. Thus, step 404may comprise identifying a completed entry having been entered in the Document Registry, activities associated with an entry being initiated or anywhere in between.

In step 406, a unique identifier corresponding to the registration identified in step 404 is determined. For example, the moniker of the document or object registered in the Document Registry may be determined. Such a determination may comprise, for example, “sniffing” a data stream or communication mechanism for such identifiers. In a more integrated embodiment (e.g., in embodiments in which the process 400 is integrated into other processes, such as a process which causes the registration of the document in the Document Registry), step 406 may comprise receiving an indication of the unique identifier from another process or device (e.g., a server device which generates the unique identifier may transmit an indication of the identifier to process 400). The unique identifier may comprise an identifier that serves as a “key” or credential which allows modification or removal of the associated entry in the Document Registry. In other words, in some embodiments, an application attempting to modify or remove an entry from the Document Registry may be queried for the unique identifier (e.g., moniker) prior to the requested modification or removal being authorized or executed. Thus, identifying the unique identifier in step 406 allows process 400 to perform step 408.

In step 408 the unique identifier determined in step 406 is utilized to remove the registry of the document identifier in step 404 from the Document Registry. In one embodiment, the process 400 may be operable to access the Document Registry directly and cause a modification of entries therein, such that the entry for the document identified in step 504 is removed. In another embodiment, the process 400 may invoke another process or subroutine (of Document Registry Application 203 or another application) in order to remove the entry. For example, the process 400 may run the RevokeActiveObject API (which causes an entry to be removed from the ROT) and provide the unique identifier determined in step 406 to effectuate the removal of the entry. In the Windows™ environment the RevokeActiveObject API is typically used by an application which previously opened a document and thus caused an entry in the Document Registry to reflect that an instance of the document is running In the presently described embodiments, however, another application that is distinct from the application which opened a particular document and caused the entry of it to be added to the Document Registry to use the RevokeActiveObject API (and the unique identifier “sniffed” or otherwise determined in step 408) to remove the entry from the Document Registry even though the document in question remains open and running Thus, another application which subsequently attempts to access the document by checking the Document Registry (e.g., ROT) and would otherwise find the entry and be able to access the document will not, as a result of step 408, find the entry and thus attempt to open another instance of the document. Accordingly, if the document in question is a restricted document, the application attempting to open it will be prompted to provide the appropriate access credentials (which it would not have been prompted for under the prior art process in which using an open instance of the document identified in the ROT bypasses any requirements for access credentials to a restricted document). Of course, process 408 may comprise any command, API or subroutine other than the RevokeActiveObject, which was discussed for illustrative purposes only.

In some embodiments, an alternative to removing an entry from a Document Registry may be to modify a status of the entry for the document in question, such that it is indicated as no longer active or available for access. For example, in some embodiments a Document Registry may comprise a listing of not only currently active or open documents, but of any documents previously opened. In such embodiments, the Document Registry may store a status or indicator in association with each record of a document, the status or indicator operable to communicate whether a respective document is currently open and available for access (e.g., a status of “open” or “running” for open documents and a status of “close” or “inactive” for documents which have been closed). In such embodiments, step 408 may comprise modifying (or directing an application to modify) a status of a document to indicate that it is no longer active, running or open, irrespective of whether it actually is or not.

Turning now to FIG. 5, illustrated therein a flowchart of an example process 500 consistent with some embodiments described herein. In one embodiment, the process 500 is performed by a computing device 200 (which may, as described herein, comprise a user device 120 or a server device 110). For example, the process 500 may be a process of an application (e.g., a Document Registry Application 203 of computing device 200), which runs on a computing device in order to monitor entries made in a Document Registry (e.g., the ROT) by other applications (e.g., an Application X 205 or an Application Y 207 of computing device 200). The process 500 is consistent with embodiments in which only entries for documents determined to be restricted documents (or which otherwise satisfy or correspond to a predetermined characteristic) are removed from the Document Registry (such that entries for documents which do not require a password or which are not otherwise restricted documents are not removed or modified).

In step 502, a registry of files of a computing device is monitored. In step 504, the monitoring results in an identification of a registration, by another software application, of a file in the registry. Steps 502 and 504 may be similar to steps 402 and 404, respectively, of process 400 (described with respect to FIG. 4 above) and thus will not be described in detail again for purposes of brevity.

In step 506 it is determined, for the file which is being registered in the registration identified in step 504, whether a characteristic of the file corresponds to a predetermined characteristic. In some embodiments, this may comprise determining whether the file is a restricted file. For example, it may be determined whether the file is password protected, encrypted or authorized to be opened by only certain designated users or groups of users. The determination of step 506 may comprise, for example, locating the file and determining one or more characteristics or options for the file as it is stored. In some embodiments, the determination of step 506 may comprise attempting to open an instance of the file (e.g., in the background such that the attempted opening is not visible to a user). In some embodiments, the determination of step 506 may comprise monitoring the opening of the file by the application which is prompting the registration of the file in the Document Registry to determine whether any access credentials are required of the associated user prior to the opening of the file being completed. In some embodiments, the process 400 may be operable to access a list or table of predetermined characteristics which it is reviewing the file for in step 506. In other embodiments, the one or more predetermined characteristics may be part of the code of process 500.

If it is determined, in step 506, that a characteristic of the file does not correspond to a predetermined characteristic, the process 500 loops back to step 502 and the monitoring of the registry of files is continued. It should be noted that the step of monitoring the registry of files (step 502) may continue to be performed even as the remaining steps 504-510 of process 500 are performed, such that any additional registrations of files initiated in the meantime may be identified. This is also true of process 400 (the monitoring step 402 may continue to be performed even as the additional steps 404-408 are performed). If it is determined that the file does correspond to the predetermined characteristic, the process 500 continues to step 508, at which step a unique identifier corresponding to the file is determined. Step 508 may be similar to step 406 (of process 400) and is thus not described in detail herein for purposes of brevity. The unique identifier is then used in step 508 to remove the registration or entry associated with the file corresponding to the predetermined characteristic from the registry of files. Step 508 may be similar to step 408 (of process 400) and is thus not described in detail herein for purposes of brevity. It should be noted that step 508, as described with respect to step 408, may in some embodiments comprise modifying an entry in the registry of files as an alternative to removing the entry from the registry of files.

Process 500 may be contrasted with process 400 in that process 500 is more selective about which entries are modified or removed from a registry of files. In process 400 all entries identified are removed or modified as described. In process 500, only entries of documents which comprise a characteristic corresponding to a predetermined characteristic (e.g., restricted documents) are removed or modified. It should be noted that process 400 and process 500 may, in some embodiments, be processes (or components of applications) which are distinct from a process or applications which are operable to register an opening of a file or instance of a file in the file registry in the first place. In other words, the applications comprising the processes 400 and 500, respectively, are separate processes from a software application of a user device or a server device which is programmed to add an entry indicating an opening of a file or instance of a file in a file registry such as the ROT, and utilize the information exchanged during the registration (the unique identifier) in order to remove or modify the entry.

Turning now to FIG. 6, illustrated therein is a flowchart of an example process 600 which is consistent with some embodiments. In one embodiment, the process 600 is performed by a computing device 200 (which may, as described herein, comprise a user device 120 or a server device 110). For example, the process 600 may be a process of an application (e.g., a Document Registry Application 203 of computing device 200), which runs on a computing device in order to monitor entries made in a Document Registry (e.g., the ROT) by other applications (e.g., an Application X 205 or an Application Y 207 of computing device 200). The process 600 is consistent with embodiments in which access to restricted documents is provided only to users or applications which are able to provide the appropriate access credentials not by removing entries from a registry of files by a software application that is different from the software application which is operable to register or open the files in the first place, but by modifying the process of an application which is operable to register or open the files in the first place. Thus, for example, process 600 may comprise a process which may be added as a subroutine or substitute routine in a process of Microsoft™ Windows™ or another operating environment, such that the handling of registration of files in a registry of files is modified in a manner which closes the loophole in security identified by Applicant.

Turning now to step 602, a request to open a file using a first application is identified. The request may comprise, for example, a request from a user or application to open or otherwise access a file. In some embodiments, the request may be received by the application comprising process 600 (i.e., the same application attempting to open the file determines that a request to open the file has been received from a user (e.g., using an input device of a computing device 200)). For example, in the Microsoft™ Windows™ environment, it may be determined that a user has requested to open a file which is not registered in the ROT or another registry of files as currently running and thus a new instance of the file needs to be opened.

In step 604, it is determined whether the file corresponds to a predetermined characteristic. In other words, does one or more characteristics of the file for which the request in step 602 was identified match one or more predetermined characteristics? The step 604 may be similar to the step 506 (of process 500) described earlier and thus is not described again for purposes of brevity. If it is determined that the file does not correspond to a predetermined characteristic (e.g., the file is not a restricted file), the process 600 proceeds to step 606, in which step the file is opened. The indication of the file is then stored in the associated registry of files (step 608). In other words, if the file is determined not to correspond to a predetermined characteristic (e.g., not be a restricted file), the opening of the file and registering of it in a registry of files (e.g., the ROT of Microsoft™ Windows™) may proceed in a standard manner after step 604 (steps 602 and 604 being new and unique to a standard process of opening and registering a file in a registry of files). If, however, it is determined that the file does correspond to a predetermined characteristic, the process 600 continues to step 610.

In step 610, the file is opened but without registering the file in an associated registry of files. For example, in the Microsoft™ Windows™ environment, the file may be opened without a call to “IRunningObjectTable::Register” and/or a call to the “CreateFileMoniker” action to create a file moniker to be registered in the ROT. Thus, a subsequent user desiring to access the file (even while it is running because it has previously been opened by another user) will be required to open another instance of the file because an entry for the file will not be found in the registry of files. Thus, the subsequent user will be required to provide the appropriate access credentials if the file is a restricted file.

It should be noted that an alternative to opening the file without storing, in a registry of files, an indication of the file as being open and running, is to store an indication in the registry of files but with an indicator or flat which communicates that the file is a restricted file otherwise corresponds to a predetermined characteristic and should thus be handled or processed differently if a subsequent user or application attempts to access the file (e.g., via the Microsoft™ “Automation” feature). For example, in some embodiments different types of monikers (e.g., monikers beginning, ending or containing special symbols or digits in specified locations recognizable as conveying that the associated file is a restricted file) may be assigned by moniker providers for files which are restricted files. Thus, when an application checking the file of registries for a file to determine whether the file is already running identifies the moniker as this special type of moniker which communicates that the file is a restricted file, the application will recognize that it needs to determine and prompt a user for the appropriate access credentials associated with the restricted file (or be required to open a new instance of the restricted file such that the user is prompted for the appropriate access credentials prior to the file being opened or accessible).

It should be understood that the above are merely examples of embodiments and should not be interpreted in a limiting fashion. Modifications and alterations to one or more methods described herein could be made without departing from the spirit and scope of the present invention.

### RULES OF INTERPRETATION

Numerous embodiments have been described, and are presented for illustrative purposes only. The described embodiments are not intended to be limiting in any sense. The invention is widely applicable to numerous embodiments, as is readily apparent from the disclosure herein. These embodiments are described in sufficient detail to enable those skilled in the art to practice the invention, and it is to be understood that other embodiments may be utilized and that structural, logical, software, electrical and other changes may be made without departing from the scope of the present invention. Accordingly, those skilled in the art will recognize that the present invention may be practiced with various modifications and alterations. Although particular features of the present invention may be described with reference to one or more particular embodiments or figures that form a part of the present disclosure, and in which are shown, by way of illustration, specific embodiments of the invention, it should be understood that such features are not limited to usage in the one or more particular embodiments or figures with reference to which they are described. The present disclosure is thus neither a literal description of all embodiments of the invention nor a listing of features of the invention that must be present in all embodiments.

The terms “an embodiment”, “embodiment”, “embodiments”, “the embodiment”, “the embodiments”, “an embodiment”, “some embodiments”, “an example embodiment”, “at least one embodiment”, “one or more embodiments” and “one embodiment” mean “one or more (but not necessarily all) embodiments of the present invention(s)” unless expressly specified otherwise. The terms “including”, “comprising” and variations thereof mean “including but not limited to”, unless expressly specified otherwise.

The term “consisting of” and variations thereof mean “including and limited to”, unless expressly specified otherwise.

The enumerated listing of items does not imply that any or all of the items are mutually exclusive. The enumerated listing of items does not imply that any or all of the items are collectively exhaustive of anything, unless expressly specified otherwise. The enumerated listing of items does not imply that the items are ordered in any manner according to the order in which they are enumerated.

The term “comprising at least one of” followed by a listing of items does not imply that a component or subcomponent from each item in the list is required. Rather, it means that one or more of the items listed may comprise the item specified. For example, if it is said “wherein A comprises at least one of: a, b and c” it is meant that (i) A may comprise a, (ii) A may comprise b, (iii) A may comprise c, (iv) A may comprise a and b, (v) A may comprise a and c, (vi) A may comprise b and c, or (vii) A may comprise a, b and c.

The terms “a”, “an” and “the” mean “one or more”, unless expressly specified otherwise.

The term “based on” means “based at least on”, unless expressly specified otherwise.

The methods described herein (regardless of whether they are referred to as methods, processes, algorithms, calculations, and the like) inherently include one or more steps. Therefore, all references to a “step” or “steps” of such a method have antecedent basis in the mere recitation of the term ‘method’ or a like term. Accordingly, any reference in a claim to a ‘step’ or ‘steps’ of a method is deemed to have sufficient antecedent basis.

Headings of sections provided in this document and the title are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required, or that each of the disclosed components must communicate with every other component. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described in this document does not, in and of itself, indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

It will be readily apparent that the various methods and algorithms described herein may be implemented by, e.g., appropriately programmed general purpose computers and computing devices. Typically a processor (e.g., a microprocessor or controller device) will receive instructions from a memory or like storage device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media may include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Transmission Control Protocol, Internet Protocol (TCP/IP), Wi-Fi, Bluetooth, TDMA, CDMA, and 3G. Where databases are described, it will be understood by one of ordinary skill in the art that (i) alternative database structures to those described may be readily employed, and (ii) other memory structures besides databases may be readily employed. Any schematic illustrations and accompanying descriptions of any sample databases presented herein are illustrative arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, other formats (including relational databases, object-based models and/or distributed databases) could be used to store and manipulate the data types described herein. Likewise, object methods or behaviors of a database can be used to implement the processes of the present invention. In addition, the databases may, in a known manner, be stored locally or remotely from a device that accesses data in such a database. For example, as an example alternative to a database structure for storing information, a hierarchical electronic file folder structure may be used. A program may then be used to access the appropriate information in an appropriate file folder in the hierarchy based on a file path named in the program.

It should also be understood that, to the extent that any term recited in the claims is referred to elsewhere in this document in a manner consistent with a single meaning, that is done for the sake of clarity only, and it is not intended that any such term be so restricted, by implication or otherwise, to that single meaning.

In a claim, a limitation of the claim which includes the phrase “means for” or the phrase “step for” means that 35 U.S.C. §112, paragraph 6, applies to that limitation.

In a claim, a limitation of the claim which does not include the phrase “means for” or the phrase “step for” means that 35 U.S.C. §112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. §112, paragraph 6, applies to that step(s).

With respect to a means or a step for performing a specified function in accordance with 35 U.S.C. §112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. §112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

### CONCLUSION

While various embodiments have been described herein, it should be understood that the scope of the present invention is not limited to the particular embodiments explicitly described. Many other variations and embodiments would be understood by one of ordinary skill in the art upon reading the present description.

What is claimed:

1. A non-transitory computer-readable medium storing instructions for a processor of a computing device, the instructions causing the processor to:
monitor, via a first software application, a registry of files;
recognize, via the first software application, a registration by a second software application of a first file in the registry of files;
determine, via the first software application, a unique identifier corresponding to the registration of the first file; and
remove, via the first software application and using the unique identifier, the registration of the first file from the registry, thereby removing the unique identifier from the registry.

2. The non-transitory computer-readable medium of claim 1, wherein the instructions causing the processor to recognize comprise instructions causing the processor to:
recognize a storing in the registry of a first data uniquely identifying the second application and a second data uniquely identifying a name of the first file; and
wherein the instructions causing the processor to remove the registration of the first file comprise instructions causing the processor to:
remove both the first data and the second data from the registry.

3. The non-transitory computer-readable medium of claim 1, wherein the instructions causing the processor to determine the unique identifier comprise instructions causing the processor to:
monitor a communication from a second processor controlling access to the registry to the second application, the communication including the unique identifier; and
extract the unique identifier from the communication.

4. The non-transitory computer-readable medium of claim 3, wherein the processor comprises the second processor.

5. The non-transitory computer-readable medium of claim 3, wherein the instructions causing the processor to monitor the communication comprise instructions causing the processor to monitor the communication internal to a first computing device.

6. The non-transitory computer-readable medium of claim 5, wherein the processor comprises a processor of the first computing device.

7. The non-transitory computer-readable medium of claim 3, wherein the instructions causing the processor to monitor the communication comprise instructions causing the processor to monitor the communication from a first computing device to a second computing device.

8. The non-transitory computer-readable medium of claim 7, wherein the processor comprises a processor of one of the first computing device and the second computing device.

9. The non-transitory computer-readable medium of claim 3, wherein the instructions for causing the processor to remove the registration of the first file from the registry comprise instructions for causing the processor to:
provide the unique identifier to the second processor along with a request to remove data corresponding to the first file from the registry.

10. The non-transitory computer-readable medium of claim 1, wherein the first application resides on a first computing device and the second application resides on a second computing device.

11. The non-transitory computer-readable medium of claim 1, wherein the first application resides on a first computing device and the registry resides on a second computing device.

12. The non-transitory computer-readable medium of claim 1, wherein the instructions further comprise instructions for causing the processor to:
determine whether the first file corresponds to a predetermined characteristic; and
only removing the first file from the registry if the first file corresponds to the predetermined characteristic.

13. The non-transitory computer-readable medium of claim 12, wherein the predetermined characteristic comprises password protection being associated with the file.

14. The non-transitory computer-readable medium of claim 12, wherein the predetermined characteristic comprises encryption of the first file.

15. The non-transitory computer-readable medium of claim 12, wherein the predetermined characteristic comprises a type of file format in which the first file is stored.

16. The non-transitory computer-readable medium of claim 12, wherein the predetermined characteristic comprises a type of application comprising the second application.

17. The non-transitory computer-readable medium of claim 12, wherein the predetermined characteristic comprises an associated permission from a user of the first file to remove the first file from the registry.

18. The non-transitory computer-readable medium of claim 1, wherein the instructions further cause the processor to:
initialize the first application in response to an instruction from an authorized user of a computing device comprising the processor.

19. The non-transitory computer-readable medium of claim 1, wherein the instructions comprising instructions to monitor the registry of files comprise instructions to monitor at least one of events and calls related to storing data in the registry of files.

20. An apparatus comprising:
a processor; and
a memory, the memory storing a program for directing the processor to perform a process, wherein the processor is operable with the program to:
monitor, via a first software application, a registry of files;
recognize, via the first software application a registration by a second software application of a first file in the registry of files;
determine, via the first software application, a unique identifier corresponding to the registration of the first file; and
remove, via the first software application and using the unique identifier, the registration of the first file from the registry, thereby removing the unique identifier from the registry.
